(19) United States
(12) Patent Application Publication
(10) Pub. No.: US 2026/0001145 A1
(43) Pub. Date: Jan. 1, 2026

(54) LENGTH-ADJUSTMENT DEVICE FOR ADJUSTING A LONGITUDINAL POSITION OF A TOOL, TOOL CLAMPING APPARATUS, AND SYSTEM AND METHOD HAVING THE LENGTH-ADJUSTMENT DEVICE

(71) Applicant: E. ZOLLER GmbH & Co. KG Einstell-und Messgeraete, Pleidelsheim (DE)

(72) Inventors: Alexander ZOLLER, Pleidelsheim (DE); Christoph WUERTENBERGER, Stuttgart (DE); Christian PFAU, Ingersheim (DE)

(21) Appl. No.: 18/993,192

(22) PCT Filed: Jul. 11, 2023
(86) PCT No.: PCT/EP2023/069213

§ 371 Date: Jan. 10, 2025

(30) Foreign Application Priority Data
Jul. 11, 2022 (DE) 10 2022 117 257.0

(51) Int. Cl. B23B 31/107

(52) U.S. Cl. CPC B23B 31/1071

(57) ABSTRACT

A length-adjustment device for an adjustment of a longitudinal position of a tool in a tool receiving opening of a tool holder, with at least one exchangeable stop element for a mechanical fixing of the longitudinal position of the tool in the tool receiving opening, with a stop receiving element, supported in a longitudinally movable manner, for receiving the stop element, and with a coupling unit which is configured for an, in particular at least substantially tolerance-free, releasable coupling between the stop element and the stop receiving element along a longitudinal axis of the length-adjustment device

wherein the coupling unit has an exchange position, in which a removal and an insertion of the stop element for creating or releasing the coupling between the stop element and the stop receiving element is enabled, and has a fixing position.,

### CROSS-REFERENCE TO RELATED APPLICATIONS

This patent application is a U.S. national stage application of international patent application PCT/EP2023/069213, filed on Jul. 11, 2023, which is based on and claims priority to German patent application DE 10 2022 117 257.0, filed on Jul. 11, 2022, the contents of which are incorporated herein by reference.

### PRIOR ART

The invention concerns a length-adjustment device at least for an adjustment of a longitudinal position of a tool in a tool receiving opening of a tool holder, a tool clamping apparatus, a system, and a method for an adjustment of a longitudinal position of a tool in a tool receiving opening of a tool holder.

A length-adjustment device for an adjustment of a longitudinal position of a tool in a tool receiving opening of a tool holder, with at least one exchangeable stop element for a mechanical fixing of the longitudinal position of the tool in the tool receiving opening, with a stop receiving element, supported in a longitudinally movable manner, for receiving the stop element, and with a coupling unit which is configured for an, in particular at least substantially tolerance-free, releasable coupling between the stop element and the stop receiving element along a longitudinal axis of the length-adjustment device, has already been proposed.

The objective of the invention is in particular to provide a generic device having improved properties with regard to an adjustment of a longitudinal position of a tool in a tool receiving opening, in particular with regard to a coupling of length-adjusting pins with an axial drive in a length-adjustment device. The objective is achieved according to the invention.

### ADVANTAGES/DISCLOSURE OF THE INVENTION

The invention is based on a length-adjustment device for an adjustment of a longitudinal position of a tool in a tool receiving opening of a tool holder, with at least one exchangeable stop element for a mechanical fixing of the longitudinal position of the tool in the tool receiving opening, with a stop receiving element, supported in a longitudinally movable manner, for receiving the stop element, in particular by means of a receiving recess which partially accommodates the stop element, or by means of a magnet element exerting an attracting magnetic force onto the stop element, and with a coupling unit which is configured for an, in particular at least substantially tolerance-free, releasable coupling between the stop element and the stop receiving element along a longitudinal axis of the length-adjustment device.

It is proposed that the coupling unit has an exchange position, in which a removal and an insertion of the stop element for creating or releasing the coupling of the stop element with the stop receiving element, and in particular with a guide element that is configured at least for guiding a longitudinal movement of the stop receiving element, is enabled, and has a fixing position, in which the stop element and the stop receiving element, and in particular the guide element, are fixedly coupled with one another, wherein the exchange position is positionally fixed along the longitudinal axis, and wherein the fixing position is displaceable along the longitudinal axis.

Advantageously, a simple and fault-free exchange of the stop element can be carried out. Advantageously, a particularly quick exchange of the stop element can take place. Advantageously, a tool-free exchange of the stop element is possible. Especially advantageously, a longitudinal direction can be adjusted particularly precisely due to the fixing position being displaceable along the longitudinal axis.

Preferably the length-adjustment device is configured to retrofit an existing clamping system, in particular for commercially available universal spindles, which is why the installation space of the length-adjustment device must have a diameter of less than 8 mm. In particular, if this installation space of the length-adjustment device is increased to more than 8 mm, many of the commercially available clamping systems would have to be adapted in a constructionally complex manner.

Preferably the length-adjustment device should allow quick and/or simple, in particular automated, exchange of stop elements, such as abutment pins, e.g. for different tool holders. Preferably there are several different stop elements present, in particular a set with seven stop elements having different lengths and/or different sizes, which are configured to be exchanged very frequently, in particular several times a day, during operation. Preferably the length-adjustment device is configured to be operable by a handling robot, which is configured at least to implement the exchange of the stop element automatically, in particular quickly and reliably. Preferably the length-adjustment device is configured to ensure a longitudinal position of a tool in a tool holder that is embodied as a heat-shrink chuck, with a deviation of less than 1 μm from a desired longitudinal position, in particular from a desired length of the combination of shrunk tool and tool holder.

The tool is preferably realized as a shank tool, in particular as a machining tool, in particular as a milling and/or turning and/or another machining tool, to be used in a processing machine. Preferably the tool is configured to enter into a connection, in particular a heat-shrink connection, with the tool holder. A “tool holder” is in particular to mean a component that is configured for receiving a tool and for a connection of the tool to a machine. In particular, the tool holder is realized as a tool-machine interface. Preferably the tool holder is realized as a tool chuck, in particular a shrink chuck, preferably a heat-shrink chuck, or as a clamping chuck, e.g. a hydro-expansion chuck or a collet chuck. Preferably the length-adjustment device is configured for an adjustment of a longitudinal position of the tool in the tool receiving opening of the tool holder, in particular with high precision (μm). Preferably the longitudinal axis of the length-adjustment device runs parallel to the main extension direction of the stop receiving element and/or coincides with the main extension direction of the stop receiving element. Preferably, in particular in the case of an intended use and/or installation direction of the length-adjustment device, the longitudinal position is arranged above the length-adjustment device in the gravity direction. Preferably the stop element limits and/or defines the longitudinal position. Preferably the longitudinal position is arranged along the longitudinal axis, in particular as a prolongation of the longitudinal axis of the stop receiving element, and/or parallel to the longitudinal axis of the stop receiving element. “Configured” is in particular to mean specifically programmed, designed and/or equipped. By an object being configured for a certain function is in particular to be understood that the object fulfils and/or executes this certain function in at least one application state and/or operation state. A “longitudinal position” is in particular to mean a position along the longitudinal axis of the length-adjustment device, which is realized as a distance, in particular between the stop receiving element and the tool holder. A “main extension direction” of an object is here in particular to mean a direction which runs parallel to a longest edge of a smallest geometric cuboid just still completely enclosing the object.

In addition to heat-shrink chucks, an adjustment of tool-tool chuck combinations, in which the shank tools are first adjusted to length and clamped in a purely linear manner (hydro-expansion or collet), would also be possible with the proposed length-adjustment device. Before the length-adjustment process, in this case an MQL screw (minimal quantity lubrication screw) is firstly rotated completely downwards (such that an adjustment stroke is axially free). After the length-adjustment process, in this case the MQL screw is then rotated upwards, such that it preferably rests against a shank end of a tool shank of the clamped-in tool. This in particular has the background that advantageously an air-oil mixture of a minimal quantity lubrication of the MQL screw can be transferred, while sealed against a through-bore of the MQL screw, into possibly present cooling channels in the tool.

The stop element is preferably realized as a pin and/or as a bolt and/or as a rod and/or as a component having a comparable geometric shape. The stop element preferably has an at least substantially cylindrical outer contour, which is configured to guide the stop element during a longitudinal movement. The stop element could be realized, for example, as a hollow profile or as a solid material. The stop element is preferably made of a metallic material and/or of a plastic and/or of a glass. A “longitudinal movement” is in particular to mean a movement along the longitudinal axis of the length-adjustment device. There are preferably different implementations of the stop element, in particular with different lengths and/or different diameters. The stop element is preferably designed to be exchangeable. It is conceivable that the stop element has adjustable lengths and/or diameters. It is also conceivable that a receiving element has two or more ends for an adjustment of two or more mutually independent longitudinal positions.

The stop receiving element is preferably realized as a hollow body, in particular a hollow profile and/or a tube, and/or as a cylinder with at least one recess, in particular a hole or a blind hole. As an alternative thereto, the stop receiving element may also be realized as a solid body providing an abutment surface for the stop element. The stop receiving element is preferably made of a metallic material, in particular steel or aluminum. The stop receiving element is preferably configured to accommodate the stop element and/or to abut against the stop element and in particular to guide it perpendicularly to the longitudinal direction. The stop element is preferably supported so as to be movable relative to the stop receiving element and/or along the longitudinal axis of the length-adjustment device in the longitudinal direction and/or so as to be rotatable around the longitudinal axis of the length-adjustment device. Preferably, in and/or above the exchange position, the stop element is movable relative to the stop receiving element, in particular along the longitudinal axis of the length-adjustment device. Preferably, in the fixing position the stop element is fixedly connected with the stop receiving element, wherein the stop element and the stop receiving element are arranged so as to be immobile relative to each other.

In the exchange position, preferably an exchange of the stop element, in particular a relative movement of the stop element relative to the stop receiving element, is possible. Preferably the coupling unit releases the stop element in the exchange position. Preferably, the stop element and the stop receiving element are fixedly coupled with each other and/or fixedly positioned relative to each other in any possible fixing position. “Fixedly coupled with each other” is in particular to mean a connection which cannot be separated non-destructively or which requires a release of a magnetic adhesion. Preferably, there is a transition of the exchange position and the fixing position into each other, in particular during a movement of the stop element along the longitudinal axis of the length-adjustment device, when the coupling unit establishes a connection, in particular a form-fitting connection, between the stop element and the stop receiving element or the guide element. “Form-fitting” is in particular to mean that adjoining surfaces of components which are connected with one another in a form-fitting manner exert a holding force onto one another that acts in the normal direction of the surfaces. In particular, the components are in geometric engagement with one another.

Furthermore, it is proposed that all possible fixing positions are arranged along the longitudinal axis completely below the exchange position. Advantageously, a force for the coupling of the stop element with the stop receiving element can be reduced. Advantageously, fixing of the stop element may be brought about by a dead weight of the stop element. Advantageously, the stop element can be prevented from dropping out in the event of a faulty coupling process. Advantageously, a faulty coupling process can be prevented. The term “below” is in particular to mean a position which, in particular in the case of an intended use and/or installation direction of the length-adjustment device, is located in the effective direction of gravity. In particular, viewed along an insertion direction in which a tool is inserted into a tool holder, all possible fixing positions are arranged completely below and/or behind the exchange position. In particular, viewed along the longitudinal direction, all possible fixing positions are farther away from the tool holder than the exchange position. A “coupling” is in particular to mean a process which connects and/or separates two separate components with/from each other.

It is further proposed that the coupling unit is configured to create a form-fitting coupling between the stop element and the stop-receiving element when the stop element is inserted into the stop receiving element along the longitudinal axis. It is advantageously possible to adjust a length and/or a distance between the length-adjustment device and the tool in a particularly precise manner. The form-fitting coupling and/or uncoupling preferably takes place automatically, in particular if there is pressure and/or traction on/at the stop element positioned in the exchange position.

Moreover, alternatively thereto it is proposed that one of several possible fixing positions is arranged along the longitudinal axis in a position that is identical to the exchange position. Advantageously a compact design is enabled. In particular, an uppermost fixing position, preferably the fixing position closest to a receiving opening of the guide element for the stop element, is the fixing position which is arranged in a position identical to the exchange position. In particular, all further fixing positions, which differ from the uppermost fixing position, are arranged completely below the exchange position.

It is also proposed that the length-adjustment device comprises the guide element, which is configured at least for guiding the longitudinal movement of the stop receiving element, wherein the coupling unit is configured to generate a coupling, in particular an at least partially form-fitting coupling, between the stop element and the guide element, in particular at least in a direction along the longitudinal axis, preferably at least in an uncoupling direction. As a result, secure fastening of the stop element is advantageously achievable. It is advantageously possible to precisely define a maximal length adjustment of the stop element. In particular, the coupling generated by the coupling unit between the stop element and the guide element is configured to prevent the stop element from being, in particular non-destructively, pulled/removed out of the length-adjustment device. In particular, the coupling generated by the coupling unit between the stop element and the guide element allows an axial movement of the stop element between two end points. In particular, the coupling generated by the coupling unit between the stop element and the guide element prevents an axial movement of the stop element beyond an upper end point. In particular, the coupling generated by the coupling unit between the stop element and the guide element prevents an axial movement of the stop element beyond a lower end point. Preferably the end points are realized by the guide element, in particular by edges of the guide element and/or by boundaries of a longitudinal recess/fixing recess that has been introduced into the guide element.

Beyond this, it is proposed that the coupling unit has a maximal transverse extent of at most 1.5 times, preferably at most 1.25 times, a maximal transverse extent of the stop element. Advantageously, the length-adjustment device may be realized in a particularly compact manner. Advantageously, a coupling may also be carried out in a particularly small/greatly restricted installation space. Preferably the transverse extent of the receiving element, perpendicularly to the main extension direction, is at least substantially the same in all directions. A “transverse extent” is in particular to mean an extent perpendicular to the main extension direction of the stop receiving element and/or perpendicular to the longitudinal axis.

It is further proposed that the coupling unit has a maximal transverse extent of at most 8 mm. Advantageously, the length-adjustment device may be realized in a particularly compact manner. Advantageously, a coupling may also be carried out in a particularly small/greatly restricted installation space. It is advantageously possible to retrofit an existing construction with the coupling unit.

It is moreover proposed that the coupling unit comprises at least one form-fitting element, which is realized separately from the stop element and separately from the stop receiving element, and which is configured at least to create a form-fitting connection for an at least partially form-fitting coupling between the stop element and the stop receiving element. Advantageously, a coupling can be simplified. Advantageously, the stop element may be realized without a form-fitting element. Advantageously, the stop element can be manufactured in a simple and cost-efficient manner. Preferably, during the coupling process the form-fitting element executes a movement at least in the radial direction of the stop element. Preferably the form-fitting connection is configured for a force transmission between the stop element and the stop receiving element, in particular along the longitudinal axis of the length-adjustment device, wherein the force transmission is realized by the form-fitting element engaging behind the stop element and the stop receiving element. Preferably, in the exchange position the form-fitting element is at least substantially freely movable, in particular relative to the stop element and/or relative to the stop receiving element. “Separate” is in particular to mean a separate component. In particular, the form-fitting element may be configured, in a coupled state of the coupling unit, to be moved within the longitudinal recess/fixing recess of the guide element. In particular, in order to induce the movement of the form-fitting element in the coupled state of the coupling unit, a clamping force, by which the form-fitting element is clamped between the stop element and a closure element of the length-adjustment device, must be overcome. In particular, the form-fitting element is herein pushed over a radially inside-situated surface of the closure element. Herein, in particular during a length-adjustment process of the length-adjustment device, the form-fitting element in particular moves along with the stop element, which is in particular to be adjusted to length.

Furthermore, it is proposed that the form-fitting element is embodied as a ball or as a spring hook. The ball is preferably made of steel, glass and/or ceramic. However, it is conceivable that the ball is made of plastic or of a comparable material. Advantageously, particularly precise guidance of the stop element is enabled. The spring hook is preferably realized as a latching element, in particular as a spring-elastic latching element. Preferably the spring hook is made of a material having elastic material properties, such as spring steel. Alternatively, an embodiment with a spring hook made of a plastic and/or a rubber would also be conceivable. Preferably the form-fitting element is configured to bring about an automatic release of the form-fitting connection in the exchange position. It is also conceivable that the form-fitting element is realized as a rotary closure, such as a bayonet closure.

Furthermore, it is proposed that the stop receiving element comprises at least one coupling recess for at least partially receiving the form-fitting element, in particular in a coupled and in an uncoupled state of the coupling unit. Advantageously, a coupling process can be carried out automatically. It is advantageously possible to prevent a faulty coupling process. Preferably the at least one coupling recess is delimited at least partially, in particular circumferentially, by the stop receiving element. Preferably the at least one coupling recess of the stop receiving element is realized as a hole. By contrast, the coupling recess of the closure element, which is supported in a rotationally movable manner, may be realized as a coupling hollow, in particular as a non-continuous recess or as a closed recess. Preferably a diameter of the coupling recess corresponds at least substantially to a diameter of the form-fitting element, in particular of the ball. Preferably the number of coupling recesses corresponds to the number of form-fitting elements.

It is further proposed that the length-adjustment device comprises the guide element, which is configured to guide a longitudinal movement and/or a rotational movement of the stop receiving element. Advantageously, particularly precise adjustment of the longitudinal position is enabled. Preferably the guide element is realized as a hollow body, in particular a hollow profile and/or a tube, which is configured to guide the stop receiving element and/or the stop element along the longitudinal axis of the length-adjustment device, and in particular to limit a movement of the stop receiving element and/or of the stop element perpendicularly to the main extension direction of the stop receiving element. Preferably the guide element is fixedly connected with the length-adjustment device, in particular in a force-fitting and/or form-fitting manner. It is also conceivable that the guide element is realized integrally with the length-adjustment device and/or that the guide element is realized as a recess, in particular as a hole/blind hole, in the length-adjustment device. “Integrally” is in particular to mean connected at least by material bond, for example by a welding process, an adhesive bonding process, an injection-molding process and/or another process deemed expedient by someone skilled in the art, and/or advantageously formed in one piece, such as for example by production from a casting and/or by production in a single-component or multi-component injection-molding process, and advantageously from a single blank.

In addition, it is proposed that the guide element comprises the fixing recess, which extends along the longitudinal axis and in which the form-fitting element is axially movable when the instantaneous fixing position is displaced. This allows achieving a displaceable fixing of the stop element in an advantageously simple manner. The closure element preferably covers the entire fixing recess radially outwards.

Beyond this, it is proposed that the guide element or the rotationally-movably supported closure element comprises a coupling hollow, which is in particular situated radially inside and which allows an at least temporary evasion of the form-fitting element at least during a coupling-in and/or an uncoupling of the stop element with/from the stop receiving element. Advantageously, a force for coupling-in and/or uncoupling can be reduced. It is advantageously possible to prevent a faulty coupling process. Preferably the coupling hollow is realized as a recess that is at least partly delimited by the guide element. Preferably the coupling hollow is realized as a groove in the guide element, which is circumferential, in particular around the longitudinal axis of the length-adjustment device. Alternatively, the coupling hollow is realized as a recess in the closure element, which is approximately just of such a size that the form-fitting element can be accommodated therein. Preferably, viewed in the radial direction of the guide element, the coupling hollow is open inwards. Preferably the coupling hollow is configured to at least partly accommodate the at least one form-fitting element during a coupling-in and/or an uncoupling. Preferably the temporary evasion is limited at least substantially to the time of the coupling process and/or of the uncoupling process. In particular, the coupling hollow is arranged in a positionally fixed manner in the longitudinal direction. The coupling hollow of the closure element can be moved in the circumferential direction by a rotation of the closure element. In particular, the stop receiving element is supported so as to be movable relative to the coupling hollow.

It is further proposed that the coupling hollow is realized so as to taper obliquely at least in a coupling-in direction, which preferably runs parallel to the longitudinal direction, or at least in a circumferential direction. It is advantageously possible to prevent a faulty coupling. In particular, the angle between the coupling hollow, which tapers obliquely in the coupling-in direction, and the longitudinal axis is realized smaller than 60°, advantageously smaller than 45° and preferably smaller than 30°. Preferably the coupling hollow, which tapers obliquely in the coupling-in direction or in the circumferential direction, is configured to enable, in particular automatic, closing of the form-fitting connection between the stop element and the stop receiving element.

Moreover, it is proposed that the coupling hollow is arranged in the rotationally-movably supported closure element in such a way that it can optionally be brought into an at least partial overlap with a fixing recess of the guide element by a rotational movement of the closure element. In this way, simple actuation of the coupling unit is advantageously achievable. It is conceivable that the rotationally-movably supported closure element is held or released manually or by an (external or internal) radial, preferably pneumatically actuated, gripper, and then the overlap of the coupling hollow with the fixing recess is adjusted by a rotation of the guide element. Alternatively, the gripper may also rotate the closure element directly. In particular, at most an upper end region of the fixing recess overlaps with the coupling hollow.

Furthermore, the closure element which is supported so as to be at least longitudinally movable in a receiving recess of the stop receiving element, or a closure element which is supported so as to be rotationally movable around a guide element of the length-adjustment device, is proposed, wherein the guide element is configured at least for guiding a longitudinal movement of the stop receiving element. Advantageously, the coupling process can take place automatically. The closure element that is supported so as to be longitudinally movable is preferably realized as a bolt and/or a pin. The closure element that is supported so as to be rotationally movable is preferably realized in a tube shape or in a ring shape. Preferably, in the coupled state, the rotationally-movably supported closure element engages circumferentially around at least the guide element and/or at least the stop element. Preferably the closure element is configured for actuating and/or enabling the coupling process. Preferably the movement of the longitudinally-movably supported closure element is limited by the stop receiving element perpendicularly to the longitudinal axis of the length-adjustment device. “Longitudinally movable” is in particular to mean a movement along the longitudinal axis of the length-adjustment device. Preferably the movement of the rotationally-movably supported closure element is angle-limited by the guide element, for example to approximately 150°. In particular, the closure element is realized separately from the stop receiving element. In particular, the longitudinally-supported closure element is configured to be in contact with an end region of a coupled stop element. In particular, the rotationally-movably supported closure element is in each operation state arranged free of a contact with the stop element.

It is furthermore proposed that the closure element is configured, in an uncoupled state, for positioning the form-fitting element in a loss-proof manner. It is advantageously possible to improve a function. “Loss-proof” is in particular to mean that the form-fitting element remains in its position and in particular neither drops out nor jams with one of the adjoining components.

Preferably the closure element is configured, in an uncoupled state, in particular in the exchange position, for positioning the form-fitting element, in particular for securing the form-fitting element against dropping out. In particular, the closure element is configured, in the uncoupled state, for holding the form-fitting element in the coupling hollow and/or in the coupling recess.

It is herein proposed that the closure element comprises a permanent magnet element that is configured for the loss-proof positioning of the form-fitting element in the uncoupled state. As a result, high operational reliability is advantageously achievable. In particular, the form-fitting element is in this case made of a magnetic, in particular ferromagnetic, material. In particular, upon a rotation of the rotationally-supported closure element, the form-fitting element is detached from the permanent magnet element by the contact with the guide element.

It is further proposed that the closure element is configured, during a coupling-in process between the stop element and the stop receiving element, to release the form-fitting element for an engagement with the stop element such that the at least partially form-fitting coupling is created. Advantageously, a coupling process can be simplified. Preferably the closure element is configured to move the form-fitting element for opening and/or closing, in particular along the longitudinal axis or in the radial direction. Preferably the closure element is configured to be actuated by the stop element, in particular to be moved along the longitudinal axis by the stop element. In particular, the stop element is configured, during the coupling process or in the already coupled state, to sink the closure element farther into the receiving recess of the stop receiving element or into the fixing recess of the guide element. In particular, the longitudinally-movably supported closure element releases the form-fitting element by an evading/sinking of the closure element into the receiving recess of the stop receiving element.

Beyond this, it is proposed that the length-adjustment device comprises a reset element, which is at least configured, during an uncoupling process, to reset the form-fitting element, in particular by means of the closure element, and/or to reset the stop receiving element into an initial position ready for coupling in. Advantageously, functional reliability can be ensured. Preferably the reset element is realized as an elastically and/or visco-elastically deformable component. Preferably, a reset movement is brought about by an, in particular elastic and/or visco-elastic, re-deformation of the reset element. Preferably a reset force of the reset element is at least substantially greater than a weight force of the closure element and/or of the stop receiving element, and at least substantially smaller than a weight force of the reset element and/or of the stop element. Preferably the reset movement is brought about by removal of the weight force from the stop element. It is also conceivable that the reset movement is brought about by an, in particular pneumatic and/or hydraulic, fluidic pressure. In particular, in the initial position ready for coupling in, the closure element positions the form-fitting element in a loss-proof manner.

Furthermore, it is proposed that the reset element is realized as a compression spring, which is supported at an end region of a receiving recess of the stop receiving element and/or at an end region of a receiving recess of a base rod that supports the stop receiving element. It is advantageously possible to improve the coupling mechanism. Preferably the receiving recess is realized as a hole and/or as a recess that is, at least perpendicularly to the longitudinal axis, completely delimited and/or closed by the stop receiving element/the base rod. Preferably the compression spring is realized as a helical compression spring and/or as a plate spring and/or as an elastically deformable rubber element. By an “end region” is in particular a region to be understood which is in an uncoupled state located on a side opposite the coupling element, wherein the end region is arranged at a maximal distance of the receiving recess from the coupling element.

It is further proposed that the stop element comprises at least one engagement hollow, which is configured to bring about an engagement with the form-fitting element for creating the form-fitting connection between the stop element and the stop receiving element or the guide element. Advantageously, a stable connection can be ensured. Preferably the engagement hollow is at least substantially equivalent to the negative of the shape of the form-fitting element. Preferably the engagement hollow constitutes a form-fitting element that corresponds to the form-fitting element. Preferably the stop receiving element has a number of engagement hollows that is equal to the number of form-fitting elements. In an alternative implementation, the engagement hollow could be realized circumferentially around the stop element. Preferably the stop element delimits the coupling hollow and/or coupling hollows.

It is moreover proposed that the stop element comprises at least one further form-fitting element, which is configured to absorb a torque from the stop receiving element and/or to transmit a torque to the stop receiving element. Advantageously, a fault-free coupling process is enabled. Preferably the further form-fitting element is configured to realize a form-fitting connection with a corresponding further form-fitting element of the stop receiving element. Preferably the further form-fitting element is realized as an external hex. Preferably the corresponding further form-fitting element of the stop receiving element is realized as an internal hex. It is conceivable that the form-fitting element is realized as a three-edged part or a four-edged part or a polygonal part or a polygon-shaped element or a comparable element designed for creating a form-fitting connection.

A further possible application of the length-adjustment device concerns a length adjustment of tools exclusively by means of presetting screws or MQL screws of chucks. In this case only the rotational function of the length-adjustment device is used to facilitate an insertion of the pin into an internal hex of a presetting screw or MQL screw of the corresponding tool holder. Advantageously the length-adjustment device realizes something like a universal genius for almost all length-adjustment methods of tools known in the industry, in particular using one and the same interface. The implementation of the corresponding further form-fitting element of the stop receiving element as an internal hex (internal hexagonal recess) advantageously enables, on the one hand, a relatively great positional freedom for exchanging stop elements and, on the other hand, a transmission of a comparably large torque.

It is further proposed that the stop element has a spherical cap on an end facing towards the stop receiving element. Advantageously assembly can be simplified. Preferably the spherical cap is configured to simplify the insertion of the stop element into the stop receiving element. It would also be conceivable that the spherical cap is realized as a cone and/or as an, in particular stepped, ledge and/or as a chamfer.

Beyond this, it is proposed that the stop receiving element and/or a base rod that supports the stop receiving element is supported so as to be rotationally movable. Advantageously, a coupling process between the stop element and the stop receiving element can be simplified. Preferably the rotational movement is configured to simplify a coupling-in, in particular a production of the form-fitting connection between the form-fitting element and the engagement hollow.

Furthermore, a tool clamping apparatus, in particular a shrink-clamping apparatus, with a length-adjustment device is proposed. Advantageously, particularly precise positioning of the tool in the tool holder is enabled. In particular, the shrink-clamping apparatus comprises at least one induction heating unit for a temporary thermal expansion of a tool receiving opening of the tool holder.

Moreover, a system with the tool clamping apparatus and with a handling robot is proposed, wherein the handling robot is configured for an automated exchange of the stop element, in particular by means of a purely linear movement. It is advantageously possible to reduce costs. Alternatively, it is also conceivable that the exchange of the stop element is brought about manually, in particular manually by a human.

Furthermore, a method for coupling a stop element with a stop receiving element in a length-adjustment device is proposed, wherein the stop element and the stop receiving element are in a coupling step coupled at a positionally fixed exchange position that is situated above all fixing positions in which the stop element and the stop receiving element are connected with each other such that they are not separable without destruction. Advantageously, a particularly quick exchange of the stop element can take place. Advantageously, a tool-free exchange of the stop element is possible.

Alternatively, it is also proposed that in the method the stop element and the stop receiving element are in a coupling step coupled at a positionally fixed exchange position that is situated axially in a position that is identical to one of several different fixing positions in which the stop element and the guide element—which is configured at least for guiding the longitudinal movement of the stop receiving element—are connected with each other such that they are not separable without destruction. Advantageously, an operationally reliable and/or precise length adjustment is enabled.

The length-adjustment device according to the invention, the tool clamping apparatus according to the invention, the system according to the invention and the method according to the invention shall here not be limited to the application and implementation described above. In particular, in order to fulfil a functionality that is described here, the length-adjustment device according to the invention, the tool clamping apparatus according to the invention, the system according to the invention and the method according to the invention may have a number of individual elements, components and units as well as method steps that differs from a number given here. Moreover, with the value ranges indicated in this disclosure, values situated within the mentioned limits shall also be considered as being disclosed and as being usable as desired.

### DRAWINGS

Further advantages will become apparent from the following description of the drawings. Three embodiments of the invention are illustrated in the drawings. The drawings, the description and the claims contain numerous features in combination. Someone skilled in the art will purposefully also consider the features individually and will find further expedient combinations. In the drawings:

FIG. 1 shows a schematic perspective illustration of a system with a tool clamping apparatus comprising a length-adjustment device and with a handling robot,

FIG. 2 shows a schematic vertical sectional view of the length-adjustment device in a coupled state,

FIG. 3 shows a schematic vertical sectional view of the length-adjustment device in an uncoupled state,

FIG. 4 shows a schematic flow chart of a method for coupling a stop element of the length-adjustment device with a stop receiving element of the length-adjustment device,

FIG. 5 shows a schematic sectional illustration in the longitudinal direction of an alternative implementation of a length-adjustment device with spring hooks,

FIG. 6 shows schematic sectional illustrations in the transverse direction of the alternative implementation of the length-adjustment device with spring hooks,

FIG. 7 shows a schematic vertical sectional view of a further alternative length-adjustment device in a coupled state (stop element locked),

FIG. 8 shows the schematic vertical sectional view of the further alternative length-adjustment device in the coupled state in a further fixing position (stop element locked),

FIG. 9 shows a schematic vertical sectional view of the further alternative length-adjustment device in an uncoupled state (stop element released),

FIG. 10 shows a schematic sectional illustration in the transverse direction of the further alternative implementation of the length-adjustment device along the section axis I indicated in FIG. 7, and

FIG. 11 shows a schematic sectional illustration in the transverse direction of the further alternative implementation of the length-adjustment device along the section axis Il indicated in FIG. 7.

### DESCRIPTION OF THE EXEMPLARY EMBODIMENTS

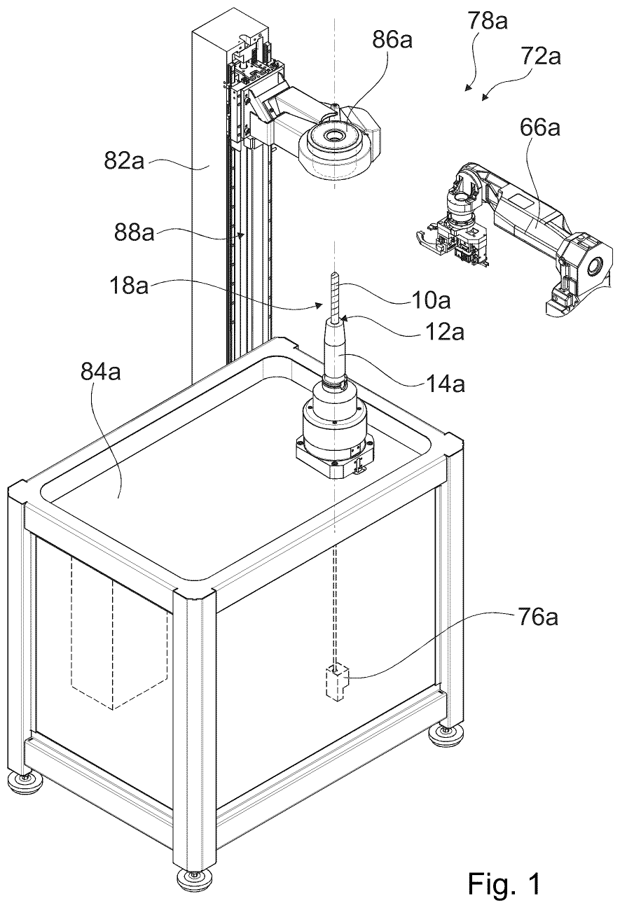

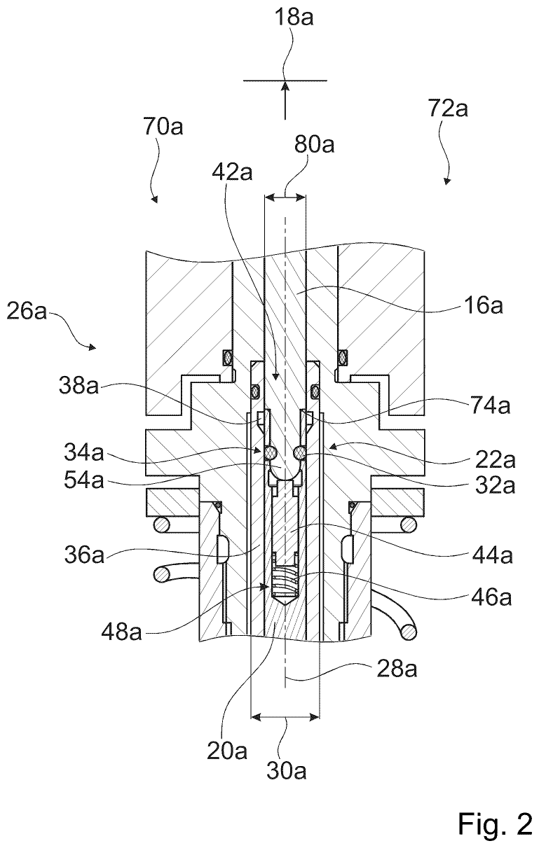

FIG. 1 shows a system with a tool clamping apparatus 78a. The tool clamping apparatus 78a is illustrated by way of example as a shrink-clamping apparatus. The tool clamping apparatus 78a comprises a length-adjustment device 72a. The length-adjustment device 72a is configured for an adjustment of a longitudinal position 18a of a tool 10a, which is realized as a shank tool, in a tool receiving opening 12a of a tool holder 14a, which is realized by way of example as a heat-shrink chuck, during a heat-shrink process. The heat-shrink chuck is in the present case realized as an induction heat-shrink chuck. The tool clamping apparatus 78a comprises an induction coil 86a. The induction coil 86a is configured for heating the tool holder 14a. The tool clamping apparatus 78a comprises a tower 82a. The tower 82a comprises a rail 88a. The induction coil 86a is traversable in the rail 88a in a vertical direction for a heating of the tool holder 14a. The system comprises a base frame 84a. The length-adjustment device 72a is arranged on the base frame 84a. The system comprises a drive unit 76a. The drive unit 76a traverses a stop element 16a of the length-adjustment device 72a in a vertical direction (see, inter alia, FIG. 2). The drive unit 76a is configured for an adjustment of a longitudinal position 18a of a stop element 16a within the tool holder 14a (see, inter alia, FIG. 2). The system comprises a handling robot 66a. The handling robot 66a is configured for an automated exchange of the stop element 16a, in particular by means of a purely linear movement. It is also conceivable that the tool exchange is brought about manually.

FIG. 2 shows a schematic illustration of a section through a portion of a length-adjustment device 72a. The length-adjustment device 72a is illustrated in a coupled state 70a. The length-adjustment device 72a comprises an exchangeable stop element 16a. The stop element 16a is configured for a mechanical fixing of the longitudinal position 18a of the tool 10a in the tool receiving opening 12a. The stop element 16a forms a stop for a lower end of a shank of the tool 10a that has been inserted into the tool receiving opening 12a during a heat-shrinking process.

The length-adjustment device 72a is configured to bring the stop element 16a into a desired/designated position within the tool receiving opening 12a of the tool holder 14a. The stop element 16a is realized in a rod-shaped manner. The stop element 16a has a cylindrical outer contour. Preferably an outer contour at least of an upper end region of the stop element 16a corresponds approximately to an inner contour of the tool receiving opening 12a of the tool holder 14a. A diameter of the cylindrical outer contour of the stop element 16a is a great deal smaller than a length of the stop element 16a. The stop element 16a could also have an angular outer contour. The stop element 16a could be realized, for example, as a three-edged part or as a four-edged part. The stop element 16a is made of a hard material, which is in particular not elastically deformable. By traversing the stop receiving element 20a along a longitudinal direction of the stop receiving element 20a, the stop element 16a can be sunk into the tool receiving opening 12a.

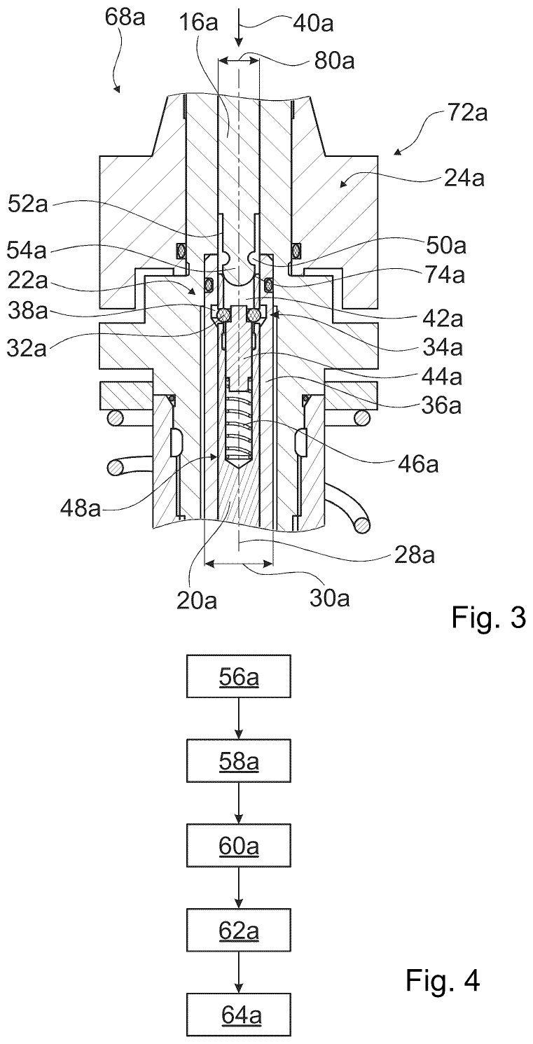

The length-adjustment device 72a comprises a stop receiving element 20a. The stop receiving element 20a is supported so as to be longitudinally movable. The stop receiving element 20a is supported so as to be rotatable. The stop receiving element 20a is configured for receiving the stop element 16a. The stop receiving element 20a is configured for coupling with the stop element 16a. In the coupled state 70a, the stop element 16a and the stop receiving element 20a are movement-bound. In an uncoupled state 68a (see FIG. 3), the stop element 16a and the stop receiving element 20a are movable relative to each other and/or rotatable relative to each other. The stop receiving element 20a has a receiving recess 42a. The receiving recess 42a is configured for at least partly receiving the stop element 16a. The receiving recess 42a is arranged centrally in the stop receiving element 20a. The receiving recess 42a is realized as a hole in the stop receiving element 20a. The receiving recess 42a is realized as a blind hole. The receiving recess 42a could also be realized, for example, as a through hole. The receiving recess 42a in the stop receiving element 20a extends in a longitudinal direction of the stop receiving element 20a. The geometric shape of the receiving recess 42a corresponds to the geometric shape of an end region of the stop element 16a. The stop receiving element 20a has a chamfer 74a. The chamfer 74a is configured to simplify an insertion of the stop element 16a into the stop receiving element 20a. The stop receiving element 20a is made of a hard material, which is in particular not elastically deformable. The stop receiving element 20a is movable in a driven manner. The stop receiving element 20a is longitudinally movable in a driven manner. The stop receiving element 20a is rotatable in a driven manner. The tool clamping apparatus 78a comprises a drive unit 76a (see FIG. 1), which is configured to move the stop receiving element 20a in the longitudinal direction and/or to rotate it around its longitudinal axis 28a.

The length-adjustment device 72a comprises a coupling unit 22a. The coupling unit 22a is configured for a tolerance-free coupling between the stop element 16a and the stop receiving element 20a along the longitudinal axis 28a of the length-adjustment device 72a. The coupling unit 22a is configured for a releasable coupling between the stop element 16a and the stop receiving element 20a along a longitudinal axis 28a of the length-adjustment device 72a. The coupling unit 22a is configured to create a form-fitting coupling between the stop element 16a and the stop receiving element 20a when the stop element 16a is inserted into the stop receiving element 20a along the longitudinal axis 28a.

The coupling unit 22a realizes an exchange position 24a (see FIG. 3). In the exchange position 24a, the stop element 16a protrudes from the tool receiving opening 12a at the top. The coupling unit 22a realizes precisely one exchange position 24a along the longitudinal axis 28a. In the exchange position 24a, a removal of the stop element 16a from the tool holder 14a and/or from the stop receiving element 20a is possible. In the exchange position 24a, an insertion of the stop element 16a into the tool holder 14a and/or into the stop receiving element 20a is possible. The exchange position 24a is configured for creating or releasing the coupling between the stop element 16a and the stop receiving element 20a. The coupling unit 22a comprises form-fitting elements 32a. In the exchange position 24a, the form-fitting elements 32a are capable of evading radially relative to the stop receiving element 20a. The evasion of the form-fitting elements 32a is designed to release the stop element 16a. The exchange position 24a is positionally fixed along the longitudinal axis 28a. The coupling unit 22a realizes a fixing position 26a (see FIG. 2). The coupling unit 22a realizes a plurality of fixing positions 26a along the longitudinal axis 28a. In the fixing position 26a, the stop element 16a and the stop receiving element 20a are fixedly coupled with each other (in a rotationally fixed and translationally fixed manner). In the fixing position 26a, no movement of the form-fitting elements 32a radially relative to the stop receiving element 20a is possible. The fixing position 26a is displaceable along the longitudinal axis 28a. All possible fixing positions 26a along the longitudinal axis 28a are arranged completely below the exchange position 24a (viewed from the tool holder 14a).

The coupling unit 22a has a maximal transverse extent 30a of at most 1.25 times a maximal transverse extent 80a of the stop element 16a. It is also conceivable that the coupling unit 22a has a maximal transverse extent 30a of at most 1.5 times the maximal transverse extent 80a of the stop element 16a. The coupling unit 22a has a maximal transverse extent 30a of at most 8 mm. The coupling unit 22a comprises several form-fitting elements 32a, which are realized separately from the stop element 16a and separately from the stop receiving element 20a. The form-fitting elements 32a are realized as balls. The form-fitting element 32a is configured to create the form-fitting connection for the form-fitting coupling between the stop element 16a and the stop receiving element 20a.

FIG. 3 shows the length-adjustment device 72a in an uncoupled state 68a. The coupling unit 22a of the length-adjustment device 72a is shown in the exchange position 24a. The stop receiving element 20a has coupling recesses 34a. The coupling recesses 34a are in each case configured for partly receiving one of the form-fitting elements 32a, in a coupled state 70a (see FIG. 2) and in an uncoupled state 68a (see FIG. 3) of the coupling unit 22a. The stop receiving element 20a has exactly as many coupling recesses 34a as form-fitting elements 32a. The stop receiving element 20a could have more coupling recesses 34a than form-fitting elements 32a. The stop receiving element 20a has coupling recesses 34a which correspond to the form-fitting element 32a. The coupling recesses 34a are realized as round through holes in the stop receiving element 20a, which extend in the radial direction of the stop receiving element 20a. The diameters of the coupling recesses 34a approximately correspond to the diameters of the respectively allocated form-fitting elements 32a.

The length-adjustment device 72a comprises a guide element 36a. The guide element 36a is realized as a hollow body. The guide element 36a is realized as a sleeve. The inner diameter of the guide element 36a approximately corresponds to the outer diameter of the stop receiving element 20a. The guide element 36a has a round outer contour. The outer contour could also be realized in angular fashion. The guide element 36a has a round inner contour. The outer diameter of the guide element 36a is a great deal smaller than the length of the guide element 36a. The guide element 36a is realized in rotationally symmetrical fashion. The maximal transverse extent 30a of the coupling unit 22a extends as far as the outer diameter of the guide element 36a. The guide element 36a is made of a metallic material. The guide element 36a is made of the same material as the stop element 16a. The guide element 36a is made of the same material as the stop receiving element 20a. The guide element 36a is installed in the tool clamping apparatus 78a so as to be immobile. The guide element 36a is fixedly connected with the tool clamping apparatus 78a. The guide element 36a is pressed as a sleeve into a recess of the tool clamping apparatus 78a. The guide element 36a could be realized as a bore. The stop receiving element 20a is inserted in the guide element 36a. The stop receiving element 20a is rotationally and/or translationally movable within the guide element 36a. The guide element 36a is configured for guiding a longitudinal movement and/or a rotational movement of the stop receiving element 20a. The guide element 36a comprises a coupling hollow 38a, which is situated radially inside. The coupling hollow 38a allows an at least temporary evasion of the form-fitting element 32a during a coupling-in and/or an uncoupling of the stop element 16a with/from the stop receiving element 20a. The coupling hollow 38a is realized circumferentially along the circumference of the guide element 36a. In the exchange position of the coupling unit 22a, the coupling hollow 38a is arranged at the level of the coupling recesses 34a/in an overlap with the coupling recesses 34a. In the fixing position of the coupling unit 22a, the coupling hollow 38a is arranged above the coupling recesses 34a. The coupling hollow 38a is realized so as to be closed in itself. The coupling hollow 38a is realized asymmetrically along the longitudinal axis 28a. The coupling hollow 38a is realized so as to taper obliquely in a coupling-in direction 40a. The obliquely-tapering coupling hollow 38a is configured to ensure that the form-fitting elements 32a move along the longitudinal axis 28a during coupling-in and uncoupling-out. In the uncoupled state 68a, the form-fitting elements 32a are at least partly arranged in the coupling hollow 38a.

The length-adjustment device 72a comprises a closure element 44a. The closure element 44a has a cylindrical shape. The closure element 44a is realized in rotationally symmetrical fashion. The closure element 44a is supported so as to be longitudinally movable in the receiving recess 42a of the stop receiving element 20a. The closure element 44a is supported so as to be rotatable in the stop receiving element 20a. The closure element 44a is configured, in an uncoupled state 68a, for positioning the form-fitting elements 32a in a loss-proof manner. The closure element 44a is configured, during a coupling-in process between the stop element 16a and the stop receiving element 20a, to release the form-fitting element 32a for an engagement with the stop element 16a in order to create the form-fitting coupling. The closure element 44a is configured to be actuated by the stop element 16a. In the uncoupled state 68a, the form-fitting elements 36a are arranged between the guide element 36a and the closure element 44a. In the coupled state 70a, the form-fitting elements 32a are arranged between the guide element 36a and the stop element 16a.

The length-adjustment device 72a comprises a reset element 46a. The reset element 46a is configured, during an uncoupling process, to reset the form-fitting element 32a, in particular by means of the closure element 44a, into an initial position ready for coupling-in. The initial position ready for coupling-in is equivalent to the coupled state 70a. The reset element 46a is realized as a compression spring. The compression spring is supported at an end region 48a of the receiving recess 42a of the stop receiving element 20a. The spring force of the compression spring is greater than the weight force of the closure element 44a. It is also conceivable that the reset movement is brought about by an, in particular pneumatic and/or hydraulic, fluidic pressure.

The stop element 16a has an engagement hollow 50a. The engagement hollow 50a is configured to bring about an engagement with the form-fitting element 32a in order to create the form-fitting connection between the stop element 16a and the stop receiving element 20a. The stop element 16a comprises a further form-fitting element 52a. The further form-fitting element 52a is configured to absorb a torque from the stop receiving element 20a and/or to transmit a torque to the stop receiving element 20a. The further form-fitting element 52a is realized as a polygon part, e.g. an external hex. The stop element 16a comprises a spherical cap 54a. The spherical cap 54a is arranged on an end of the stop element 16a that faces towards the stop receiving element 20a. The stop receiving element 20a is supported so as to be rotationally movable.

FIG. 4 shows a schematic flow chart of a method for coupling the stop element 16a with the stop receiving element 20a.

In a method step 56a, in an exchange position 24a of the coupling unit 22a, the stop element 16a is removed or inserted along the longitudinal axis 28a for creating or releasing the coupling between the stop element 16a and the stop receiving element 20a. The insertion of the stop element 16a into the stop receiving element 20a is carried out by means of a handling robot 66a. Alternatively, the insertion of the stop element 16a into the stop receiving element 20a may as well be carried out manually. During the entire insertion process, the stop receiving element 20a is rotated around the longitudinal axis 28a.

In a further method step 58a, in the exchange position 24a of the coupling unit 22a, the stop element 16a is moved downwards in the longitudinal direction of the length-adjustment device 72a. The exchange position 24a is positionally fixed along the longitudinal axis 28a. The exchange position 24a is situated above all fixing positions 26a. The form-fitting element 32a is pressed radially inwards by the coupling hollow 38a that extends obliquely downwards. The form-fitting element 32a is inserted into the coupling recess 34a. The form-fitting connection between the stop element 16a and the stop receiving element 20a is created by the form-fitting element 32a being pressed inwards. In a coupling step (method step 58a), the stop element 16a and the stop receiving element 20a are coupled at the positionally fixed exchange position 24a. The stop element 16a and the stop receiving element 20a are fixedly coupled with each other. The fixing positions 26a, the stop element 16a and the stop receiving element 20a are connected with each other in such a way that they cannot be separated without destruction.

In a further method step 60a, the stop receiving element 20a, which is connected with the stop element 16a, is moved upwards and downwards for the length-adjustment movement of the tool 10a. In a fixing position 26a, the stop element 16a and the stop receiving element 20a are displaced along the longitudinal axis 28a for a length adjustment.

In a further method step 62a, the stop element 16a is moved upwards along the longitudinal axis 28a until the exchange position 24a has been reached with the coupling unit 22a.

In a further method step 64a, the stop element 16a is moved upwards. Herein the form-fitting elements 32a are moved radially outwards and the form-fitting connection is released.

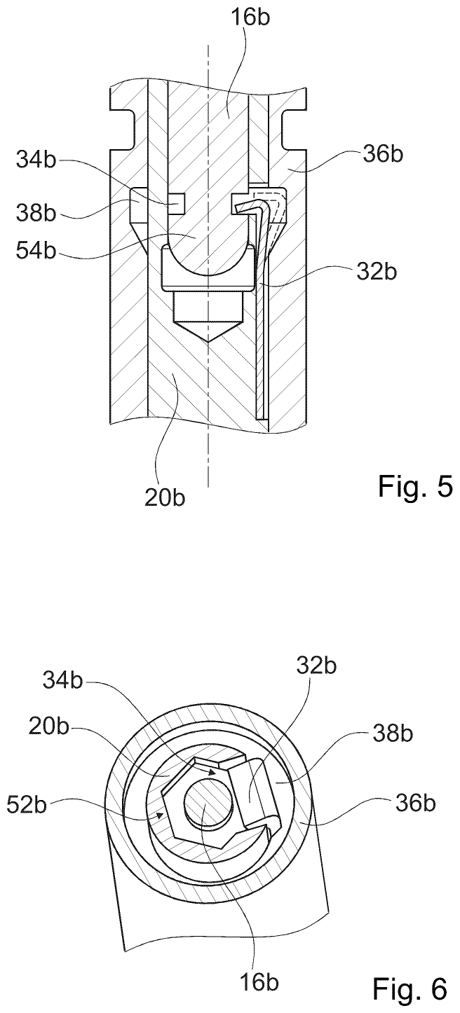

Further exemplary embodiments of the invention are shown in FIGS. 5 to 11. The following description and the drawing are limited essentially to the differences between the exemplary embodiments, wherein with regard to components having the same denomination, in particular with regard to components having the same reference numerals, in principle reference may also be made to the drawings and/or the description of the other exemplary embodiment, in particular of FIGS. 1 to 4. In order to distinguish between the exemplary embodiments, the letter a has been added to the reference numerals of the exemplary embodiment in FIGS. 1 to 4. In the exemplary embodiments of FIGS. 5 to 11, the letter a has been replaced by the letters b and c.

FIG. 5 shows a schematic sectional illustration of an alternative implementation of a length-adjustment device 72b. The length-adjustment device 72b is depicted in a coupled state 70b. The length-adjustment device 72a comprises a stop element 16b. The length-adjustment device 72b comprises a stop receiving element 20b. The stop receiving element 20b has a coupling recess 34b. The stop receiving element 20b has a receiving recess 42b. The stop element 16b is arranged in the receiving recess 42b of the stop receiving element 20b. The length-adjustment device 72b comprises a guide element 36b. The guide element 36b comprises a coupling hollow 38b. The coupling hollow 38b is realized circumferentially. The stop receiving element 20b is arranged in the guide element 36b. The stop element 16b is arranged in the guide element 36b. The length-adjustment device 72b comprises a coupling unit 22b. The coupling unit 22b comprises a form-fitting element 32b. The form-fitting element 32b is realized as a spring hook. The spring hook creates a form-fitting connection with the stop element 16b (see FIG. 5). In a coupled state 70b, the spring hook engages through the coupling recess 34b. In a coupled state, the spring hook is tensioned. In a coupled state 70b, the spring hook is elastically deformed. The coupling recess 34b is realized so as to be rectangular. The coupling hollow 38b is configured to accommodate the spring hook during an uncoupling of the stop element 16b from the stop receiving element 20b. The form-fitting element 32b, illustrated by dashed lines, shows the uncoupled state 68b of the form-fitting element 32b.

FIG. 6 shows a sectional illustration of a section in a transverse direction of the length-adjustment device 72b. The length-adjustment device 72b comprises a guide element 36b. The length-adjustment device 72b comprises a stop receiving element 20b. The stop receiving element 20b is arranged in the guide element 36b. The stop receiving element 20b is supported so as to be longitudinally and/or rotationally movable in the guide element 36b. The length-adjustment device 72b comprises a stop element 16b. The stop element 16b is arranged in the stop receiving element 20b. The stop element 16b comprises a further form-fitting element 52b. The further form-fitting element 52b is realized as an external hex. The stop receiving element 20b comprises an internal hex. The stop element 16b and the stop receiving element 20b realize a form-fitting connection. The length-adjustment device 72b comprises a coupling unit 22b. The coupling unit 22b is shown in the coupled state 70b. The coupling unit 22b comprises a form-fitting element 32b. The coupling unit 22b has a coupling recess 34b. The form-fitting element 32b engages into the coupling recess 34b. The coupling recess 34b has the same geometric shape as the form-fitting element 32b.

The guide element 36b comprises a coupling hollow 38b. The coupling hollow 38b is configured for accommodating the form-fitting element 32b in an uncoupled state 68ba.

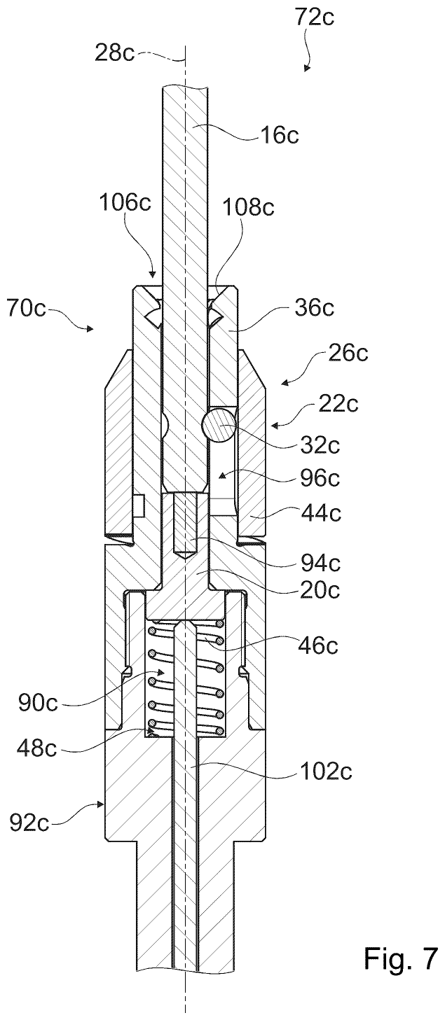

FIG. 7 shows a schematic vertical sectional view of a portion of a further alternative length-adjustment device 72c. The further alternative length-adjustment device 72c is shown in a coupled state 70c. The further alternative length-adjustment device 72c comprises an exchangeable stop element 16c. The stop element 16c is made of a magnetic material, for example a magnetic steel. The length-adjustment device 72c comprises a stop receiving element 20c. The stop receiving element 20c is supported so as to be longitudinally movable.

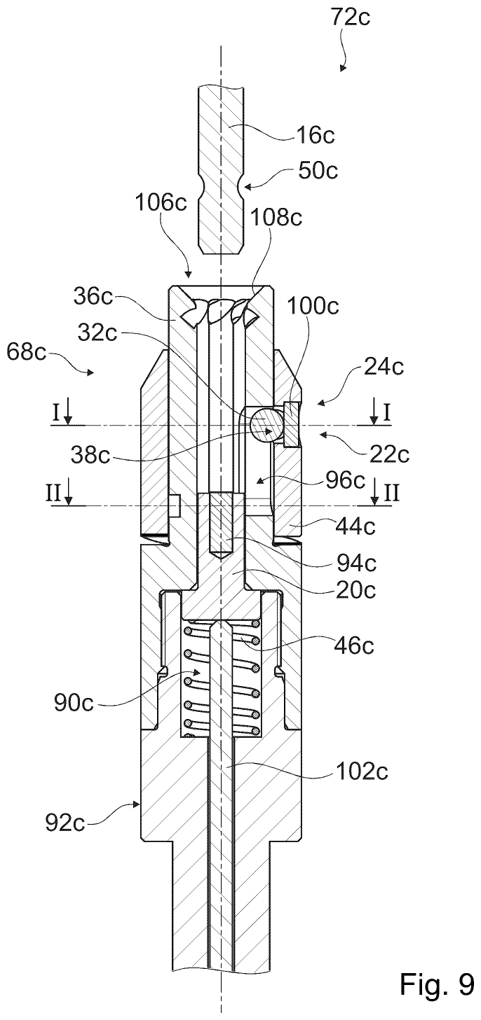

The stop receiving element 20c is supported so as to be rotatable. The stop receiving element 20c forms a stop for the stop element 16c. The stop receiving element 20c is configured for a coupling with the stop element 16c. The stop receiving element 20c comprises a magnet element 94c. The stop receiving element 20c is configured for a magnetic coupling with the stop element 16c. The magnet element 94c of the stop receiving element 20c exerts a magnetic attraction force onto the stop element 16c. As a result of the coupling, the stop receiving element 20c and the stop element 16c are only movable conjointly in the coupled state 70c. In the coupled state 70c, the stop element 16c and the stop receiving element 20c are movement-bound. However, in an uncoupled state 68c (see FIG. 9), the stop element 16c and the stop receiving element 20c are movable relative to each other and/or rotatable relative to each other. In this exemplary embodiment, the stop receiving element 20c is realized free of a receiving recess for receiving the stop element 16c. The stop receiving element 20c is longitudinally movable in a driven manner. The further alternative length-adjustment device 72c comprises a base rod 92c. The base rod 92c is supported so as to be rotationally movable. The base rod 92c comprises a pin 102c. The pin 102c is supported so as to be longitudinally movable. The stop receiving element 20c adjoins the pin 102c of the base rod 92c. The base rod 92c, in particular the pin 102c of the base rod 92c, supports the stop receiving element 20c. The pin 102c of the base rod 92c is configured to transmit/exert a longitudinal movement onto the stop receiving element 20c and in the coupled state 70c also onto the stop element 16c. The pin 102c of the base rod 92c pushes the stop receiving element 20c up and down in a recess of the length-adjustment device 72c that supports the stop receiving element 20c. A tool clamping apparatus 78c comprising the length-adjustment device 72c has a drive unit 76c (see also FIG. 1), which is configured at least for moving the pin 102c of the base rod 92c in the longitudinal direction.

The length-adjustment device 72c comprises a coupling unit 22c. The length-adjustment device 72c comprises a guide element 36c. The guide element 36c is configured for guiding the stop element 16c during the coupling-in process or during the uncoupling process or during the length adjustment. The guide element 36c is realized as a hollow body. The guide element 36c is installed in the tool clamping apparatus 78c so as to be immobile. The stop receiving element 20c is inserted in the guide element 36c. The stop receiving element 20c is translationally movable within the guide element 36c. The guide element 36c is configured for guiding a longitudinal movement of the stop receiving element 20c. The coupling unit 22c is configured for a releasable coupling between the stop element 16c and the guide element 36c. The coupling unit 22c is configured for a releasable coupling between the stop element 16c and the guide element 36c at least in a radial direction. The coupling unit 22c is configured to generate a partially form-fitting coupling between the stop element 16c and the guide element 36c. The guide element 36c is configured for receiving the stop element 16c. The guide element 36c has an insertion opening 106c into which the stop element 16c is insertable. The insertion opening 106c comprises an internal hex. The insertion opening 106c comprises an insertion chamfer 108c for facilitating the insertion of the stop element 16c.

The coupling unit 22c realizes an exchange position 24c (see FIG. 9). The coupling unit 22c realizes precisely one exchange position 24c along a longitudinal axis 28c of the length-adjustment device 72c. In the exchange position 24c, a removal of the stop element 16c is possible, in particular without a great force input and without destruction. In the exchange position 24c, an insertion of the stop element 16c is possible, in particular without a great force input and without destruction. The exchange position 24c is configured for creating or releasing the coupling between the stop element 16c and the guide element 36c. The exchange position 24c is positionally fixed along the longitudinal axis 28c. The coupling unit 22c comprises a form-fitting element 32c. The form-fitting element 32c is realized as a ball. The form-fitting element 32c is configured to create a partially form-fitting connection between the stop element 16c and the guide element 36c. In the exchange position 24c, the form-fitting element 32c is capable of evading radially relative to the stop element 16c or to an opening, in particular of the guide element 36c, which accommodates the stop element 16c in the coupled state 70c. The evasion of the form-fitting elements 32c is intended to release the stop element 16c. The guide element 36c has a fixing recess 96c. The fixing recess 96c extends along the longitudinal axis 28c.

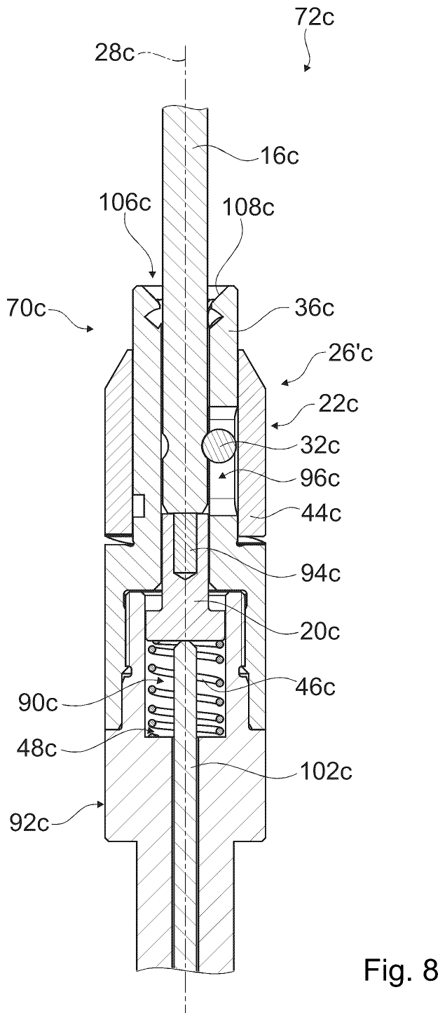

The coupling unit 22c realizes a first fixing position 26c (see FIG. 7). The coupling unit 22c realizes a second fixing position 26′c (see FIG. 8). The coupling unit 22c realizes a plurality of fixing positions 26c along the longitudinal axis 28c. In the fixing position 26c, 26′c, the stop element 16c and the stop receiving element 20c are coupled with each other in a translationally fixed manner. The fixing position 26c, 26′c is displaceable along the longitudinal axis 28c. All possible fixing positions 26′c—with the exception of the first fixing position 26c—along the longitudinal axis 28c are arranged completely below the exchange position 24c (viewed from the tool holder 14c). The first fixing position 26c is arranged in a position identical to the exchange position 24c. In the fixing positions 26c, no movement of the form-fitting element 32c is possible radially relative to the stop element 16, respectively radially relative to a receiving recess 90c of the base rod 92c which accommodates the stop element 16c in the coupled state 70c.

The length-adjustment device 72c comprises a closure element 44c. The closure element 44c is tube-shaped/ring-shaped. The closure element 44c engages around the guide element 36c on the outer circumference thereof. The closure element 44c is supported so as to be rotationally movable. The closure element 44c is supported so as to be rotationally movable around the guide element 36c. The closure element 44c can be gripped on its outer circumference by a robot or by an operator. The closure element 44c is immobile along the longitudinal axis 28c. The closure element 44c is configured, in an uncoupled state 68c of the length-adjustment device 72c, to position the form-fitting element 32c in a loss-proof manner. The closure element 44c is configured, during a coupling-in process between the stop element 16c and the guide element 36c/during a fixing of the stop element 16c in the length-adjustment device 72c, to release the form-fitting element 32c for an engagement with the stop element 16c for creating the partially form-fitting coupling. The closure element 44c is configured to be actuated externally.

The closure element 44c comprises a coupling hollow 38c, which is situated radially inside. The coupling hollow 38c allows an at least temporary evasion of the form-fitting element 32c during a coupling-in and/or an uncoupling of the stop element 16c. The coupling hollow 38c is arranged at the level of the coupling recesses 24c. The coupling hollow 38c is arranged in the rotationally-movably supported closure element 44c in such a way that it can optionally be brought into an at least partial overlap with the fixing recess 96c of the guide element 36c (see FIG. 9) or can be brought out of an overlap with the fixing recess 96c (see FIG. 7 or 8) by a rotational movement of the closure element 44c. In all fixing positions 26′c other than the first fixing position 26c, the coupling hollow 38c is arranged above the form-fitting element 34c. The coupling hollow 38c is realized so as to be asymmetrical along a circumferential direction 98c of the closure element 44c. The coupling hollow 38c is realized so as to taper obliquely in the circumferential direction 98c. The obliquely-tapering coupling hollow 38c is configured to ensure a movement of the form-fitting elements 32c in the radial direction during coupling-in and uncoupling of the stop element 16c. Only in the uncoupled state 68c, the form-fitting elements 32c are arranged at least partly within the coupling hollow 38c. The closure element 44c comprises a permanent magnet element 100c. The permanent magnet element 100c is configured for a loss-proof positioning of the form-fitting element 32c in the uncoupled state 68c. The permanent magnet element 100c is arranged in the coupling hollow 38c. The permanent magnet element 100c is arranged on an inner wall of the coupling hollow 38c or at least partly realizes the coupling hollow 38c. The form-fitting element 32c is realized as a magnetic ball, for example a magnetic steel ball, which is capable of interacting magnetically with the permanent magnet element 100c, and which is in particular magnetically attracted by the permanent magnet element 100c.

The length-adjustment device 72c comprises a reset element 46c. The reset element 46c is configured, during an uncoupling process, to reset the stop receiving element 20c into an initial position ready for coupling-in. The stop receiving element 20c forms a spring thrust piece, which is supported at the reset element 46c. The reset element 46c is configured, in the uncoupled state 68c, to reset the stop receiving element 20c into an uppermost position, as illustrated in FIG. 9. A displacement of the stop element 16c from the first fixing position 26c into one of the further fixing positions 26′c brings about a tensioning of the reset element 46c and/or an insertion of the stop receiving element 20c into the receiving recess 90c of the base rod 92c (see FIG. 8). The reset element 46c is realized as a compression spring. The compression spring is supported at an end region 48c of the receiving recess 90c of the base rod 92c. The compression spring is supported at the stop receiving element 20c.

In FIGS. 7 and 8, in which the coupling hollow 38c of the closure element 44c does not overlap with the fixing recess 96c of the guide element 36c, the closure element 44c is shown in a rotational position that differs from the rotational position in FIG. 9, in which the coupling hollow 38c of the closure element 44c overlaps with the fixing recess 96c of the guide element 36c.

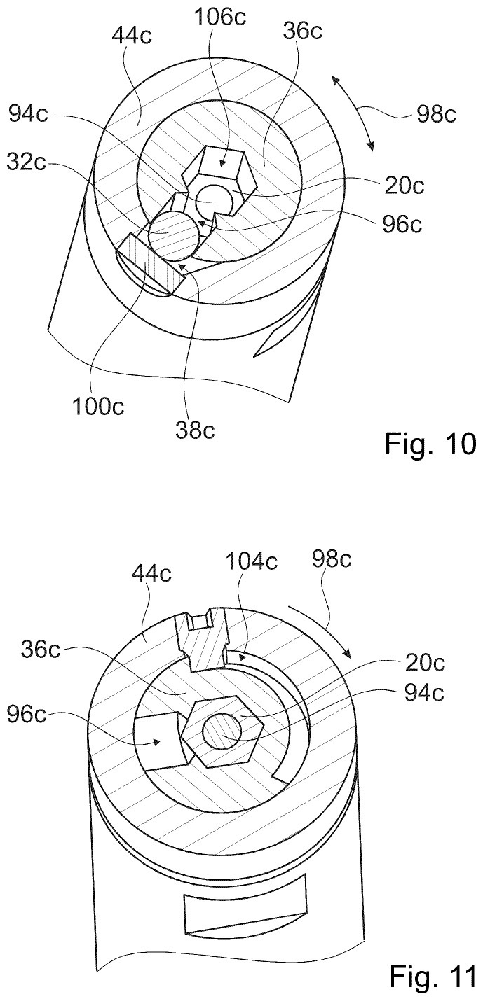

FIG. 10 shows a schematic sectional illustration in the transverse direction of the further alternative length-adjustment device 72c in the uncoupled state 68c along the section axis I indicated in FIG. 9, which intersects with the further alternative length-adjustment device 72c in the region of the coupling hollow 38c. The form-fitting element 32c is arranged partly in the coupling hollow 38c of the closure element 44c and partly in the fixing recess 96c of the guide element 36c. The form-fitting element 32c adheres magnetically to the permanent magnet element 100c of the closure element 44c. If a stop element 16c were to be inserted, the form-fitting element 32c would not be able to exert a fixing effect on the stop element 16c. If the closure element 44c were to be rotated along the circumferential direction 98c, the form-fitting element 32c would be guided out of the coupling hollow 38c and would be clamped in the intermediate space realized by the fixing recess 96c between the stop element 16c and the closure element 44c.

FIG. 11 shows a schematic sectional illustration in the transverse direction of the further alternative length-adjustment device 72c in the uncoupled state 68c along the section axis II indicated in FIG. 7, which is situated below the section axis I. The section axis Il intersects with the further alternative length-adjustment device 72c in the region of the fixing recess 96c below the coupling hollow 38c. The further alternative length-adjustment device 72c comprises a rotation limiting device 104c. The rotation limiting device 104c limits the relative rotation between the closure element 44c and the guide element 36c to approximately 150°. Larger or smaller limited rotation-angle ranges or an unlimited rotation-angle range are of course conceivable. In the case shown, the rotation limiting device 104c comprises a pin which is allocated to the closure element 44c and can be moved back and forth between two end stops in a groove of the guide element 36c.

1. A length-adjustment device for an adjustment of a longitudinal position of a tool in a tool receiving opening of a tool holder, with at least one exchangeable stop element for a mechanical fixing of the longitudinal position of the tool in the tool receiving opening, with a stop receiving element, supported in a longitudinally movable manner, for receiving the stop element, in particular by means of a receiving recess which partially accommodates the stop element, or by means of a magnet element exerting an attracting magnetic force onto the stop element, and with a coupling unit which is configured for an, in particular at least substantially tolerance-free, releasable coupling between the stop element and the stop receiving element along a longitudinal axis of the length-adjustment device, characterized in that wherein the coupling unit has an exchange position, in which a removal and an insertion of the stop element for creating or releasing the coupling between the stop element and the stop receiving element is enabled, and has a fixing position, in which the stop element and the stop receiving element are fixedly coupled with each other, wherein the exchange position is positionally fixed along the longitudinal axis and wherein the fixing position is displaceable along the longitudinal axis.

2. The length-adjustment device according to claim 1, wherein all possible fixing positions are arranged along the longitudinal axis completely below the exchange position.

3. The length-adjustment device according to claim 1, wherein the coupling unit is configured to create a form-fitting coupling between the stop element and the stop receiving element when the stop element is inserted into the stop receiving element along the longitudinal axis.

4. The length-adjustment device according to claim 1, wherein one of several possible fixing positions is arranged along the longitudinal axis in a position that is identical to the exchange position.

5. The length-adjustment device according to claim 1, further comprising a guide element, which is configured at least for guiding a longitudinal movement of the stop receiving element, the coupling unit being configured for creating a coupling between the stop element and the guide element.

6. The length-adjustment device according to claim 1, wherein the coupling unit has a maximal transverse extent of at most 1.5 times, preferably at most 1.25 times, a maximal transverse extent of the stop element.

7. The length-adjustment device according to claim 1, wherein the coupling unit has a maximal transverse extent of at most 8 mm.

8. The length-adjustment device according to claim 1, wherein the coupling unit comprises at least one form-fitting element which is realized separately from the stop element and separately from the stop receiving element and which is configured at least for creating a form-fitting connection for an at least partially form-fitting coupling between the stop element and the stop receiving element.

9. The length-adjustment device according to claim 8, wherein the form-fitting element is realized as a ball or as a spring hook.

10. The length-adjustment device according to claim 8, wherein the stop receiving element has at least one coupling recess for at least partially receiving the form-fitting element, in particular in a coupled and in an uncoupled state of the coupling unit.

11. The length-adjustment device according to claim 1, cfurther comprising a guide element configured for guiding a longitudinal movement and/or a rotational movement of the stop receiving element.

12. The length-adjustment device according to claim 11, wherein the coupling unit comprises at lest one form-fitting element which is realized separately from the stop element and separately from the stope receiving element and which is configured at least for creating a form-fitting connection for an at least partially form-fitting coupling between the stop element and the stop receiving element, and wherein the guide element has a fixing recess, which extends along the longitudinal axis and in which the form-fitting element is axially movable when the instantaneous fixing position is displaced.

13. The length-adjustment device according to claim 1, comprising a closure element which is supported so as to be longitudinally movable in a receiving recess of the stop receiving element, or comprising a closure element which is supported so as to be rotationally movable around a guide element of the length-adjustment device, wherein the guide element is configured at least for guiding a longitudinal movement of the stop receiving element.

14. The length-adjustment device according to claim 11, wherein the coupling unit comprises at least one form-fitting element which is realized separately from the stop element and separately from the stop receiving element and which is configured at least for creating a form-fitting connection for an at least partially form-fitting coupling between the stop element and the stop receiving element, and wherein the guide element or the rotationally-movably supported closure element comprises a coupling hollow, which is in particular situated radially inside and which allows an at least temporary evasion of the form-fitting element at least during a coupling-in and/or an uncoupling of the stop element, in particular with/from the stop receiving element.

15. The length-adjustment device according to claim 14, wherein the coupling hollow is realized so as to taper obliquely at least in a coupling-in direction or at least in a circumferential direction.

16. The length-adjustment device according to claim 14, wherein the coupling unit comprises at least one form-fitting element which is realized separately from the stop element and separately from the stop receiving element and which is configured at least creating a form-fitting connection for an at least partially form-fitting coupling between the stop element and the stop receiving element, wherein the guide element has a fixing recess, which extends along the longitudinal axis and in which the form-fitting element is axially movable when the instantaneous fixing position is displace, and wherein the coupling hollow is arranged in the rotationally-movably supported closure element in such a way that it can optionally be brought into an at least partial overlap with a fixing recess of the guide element by a rotational movement of the closure element.

17. The length-adjustment device according to claim 10, wherein the coupling unit comprises at least one form-fitting element which is realized separately from the stop element and separately from the stop receiving element and which is configured at least for creating a form-fitting connection for an at least partially form-fitting coupling between the stop element and the stop receiving element, and wherein the closure element is configured, in an uncoupled state, to position the form-fitting element in a loss-proof manner.

18. The length-adjustment device according to claim 17, wherein the closure element comprises a permanent magnet element configured for the loss-proof positioning of the form-fitting element in the uncoupled state.

19. The length-adjustment device according to claim 10, wherein the coupling unit comprises at least one form-fitting element which is realized separately from the stop element and separately from the stop receiving element and which is configured at least for creating a form-fitting connection for an at least partially form-fitting coupling between the stop element and the stop receiving element, and wherein the closure element is configured, during a coupling-in process between the stop element and the stop receiving element, to release the form-fitting element for an engagement with the stop element such that an at least partially form-fitting coupling is created.

20. The length-adjustment device according to claim 8, also comprising a reset element, which is at least configured, during an uncoupling process, to reset the form-fitting element, in particular by means of the closure element, and/or to reset the stop receiving element into an initial position ready for coupling-in.

21. The length-adjustment device according to claim 20, wherein the reset element is realized as a compression spring which is supported at an end region of a receiving recess of the stop receiving element and/or at an end region of a receiving recess of a base rod that supports the stop receiving element.

22. The length-adjustment device according to claim 8, wherein the stop element comprises at least one engagement hollow, which is configured to bring about an engagement with the form-fitting element in order to create a form-fitting connection between the stop element and the stop receiving element or the guide element.

23. The length-adjustment device according to claim 1, wherein the stop element comprises at least one further form-fitting element configured to absorb a torque from the stop receiving element and/or to transmit a torque to the stop receiving element.

24. The length-adjustment device according to claim 1, wherein the stop element has a spherical cap on an end facing towards the stop receiving element.

25. The length-adjustment device according to claim 1, wherein the stop receiving element and/or a base rod that supports the stop receiving element is supported so as to be rotationally movable.

26. A tool clamping apparatus, in particular a shrink-clamping apparatus, with a length-adjustment device according to claim 1.

27. A system with a tool clamping apparatus according to claim 26 and with a handling robot, wherein the handling robot is configured for an automated exchange of the stop element, in particular by means of a purely linear movement.

28. A method for coupling a stop element with a stop receiving element in a length-adjustment device according to claim 1.

29. The method according to claim 28, wherein the stop element and the stop receiving element are in a coupling step coupled at a positionally fixed exchange position that is situated above all fixing positions in which the stop element and the stop receiving element are connected with each other such that they are not separable without destruction.

30. The method according to claim 28, wherein the stop element and the stop receiving element are in a coupling step coupled at a positionally fixed exchange position that is situated axially in a position identical to one of several different fixing positions in which the stop element and a guide element, which is configured at least for guiding a longitudinal movement of the stop receiving element, are connected with each other such that they are not separable without destruction.
